(19) United States
(12) Patent Application Publication
(10) Pub. No.: US 2006/0080078 A1
(43) Pub. Date: Apr. 13, 2006

(54) Adaptive device for memory simulator

(76) Inventors: Jing-Rung Wang, Hsin-Tien City (TW); Chia-Hsing Yu, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/078,345

(22) Filed: Mar. 14, 2005

(30) Foreign Application Priority Data
Oct. 8, 2004 (TW) 093130556

(51) Int. Cl. G06F 9/455

(52) U.S. Cl. 703/26

(57) ABSTRACT

An adaptive device for a memory simulator is capable of connecting a transmission interface of a memory simulator to a memory socket of a motherboard, in which the transmission interface is not compatible to the memory socket. The adaptive device includes first and second connectors respectively suitable for connecting with a first read-only memory socket and a second read-only memory socket. If the first connector is connected with the first read-only memory socket, a controller of the adaptive device performs a first access mode to access the system code and passes it to the first read-only memory socket via the first connector. If the second connector is connected with the second read-only memory socket, the controller performs a second access mode to access the system code and passes it to the second read-only memory socket via the second connector for the motherboard to execute it.

### BACKGROUND OF THE INVENTION

1. Field of the Invention

The present invention is related to an adaptive device for a memory simulator, and more particularly, to a device capable of connecting a transmission interface of a memory simulator to a memory socket of a motherboard, in which the transmission interface doesn't match the memory socket.

2. Description of Related Art

In the present, computer systems are versatile and convenient for people. In general, they are used to deal with documents, search information via Internet and provide video entertainments. With the increase of users' requirements, the functions of computer systems, e.g. the functions of computer peripheral, need to be improved unceasingly. However, every time when the transmission interfaces of computer peripheral or central processing units (CPU) are improved, basic input/output systems (BIOS) and standards for motherboards also need to be modified.

Basic input/output systems are firmware generally stored in read-only memories (ROM). When BIOS developers need to test BIOS codes, they usually transmit the BIOS programs codes to memory simulators in advance. Then, the memory simulators simulate the read-only memories of the motherboards to test the BIOS programs. In this way, during test process, the BIOS developers do not need to waste their time to record the BIOS codes on the read-only memories repeatedly. They can modify the BIOS codes at any time.

In the early stages, the motherboards only have the ROM sockets of industry standard architecture (ISA) transmission interfaces. Hence, the present memory simulators only have the ISA transmission interfaces as well. Reference is made to FIG. 1, which is a block diagram of a conventional memory simulator. In order to test the BIOS code, the BIOS developer first transmits the BIOS code to an ISA memory simulator 12 via a personal computer (PC) 10. The ISA memory simulator 12 communicates with a motherboard 15 via an adaptive device 20, which is used to temporarily store the signals transferred. The adaptive device 20 has ISA memory connectors 22, 24, which are connected to the ISA memory simulator 12 and the ISA memory socket 17, respectively.

When the motherboard 15 is activated, it first sends a control signal to a buffer unit 26 via the ISA memory socket 17 and the ISA memory connector 24 to store the control signal temporarily. Then, the control signal is passed from the buffer unit 26 to the ISA memory simulator 12 via the ISA memory connector 22 for accessing the BIOS code. On the other hand, when the ISA memory simulator 12 transmits the BIOS code via the ISA memory connector 22, the BIOS code is also stored in the buffer unit 26 temporarily. Then, the BIOS code is passed from the buffer unit 26 to the ISA memory socket 17 via the ISA memory connector 24 for the motherboard 15 to execute and test the BIOS code.

Recently, the structure of the present motherboard is improved unceasingly and made more and more compact. Due to the current trend and requirements, Intel Company proposed a new transmission interface structure, called low pin count (LPC) transmission interface. Hence, ISA read-only memory socket (it has 30 pins) is gradually replaced by LPC read-only memory socket (it only has 7 pins). Since the number of pins for LPC transmission interface is much smaller than that for ISA transmission interface, using LPC transmission interface greatly reduces the volume and cost of the memory socket of the motherboard so that the design for the motherboard is also reduced and simplified. Hence, LPC transmission interface is gradually used in the motherboard.

However, all of the present memory simulators still use ISA transmission interface. In other word, the present memory simulators cannot be used together with the memory sockets of LPC transmission interface. Hence, the present invention provides an adaptive device to solve this problem. By using the present invention, the present memory simulators can be used with the memory sockets of LPC transmission interface.

### SUMMARY OF THE INVENTION

An objective of the present invention is to provide an adaptive device for a memory simulator that is capable of converting signal formats to make the memory simulator adapted to a read-only memory socket complied with a different transmission interface standard.

Another objective of the present invention is to provide an adaptive device for a memory simulator that is capable of intercepting a post/debug code generated by a motherboard that executes a system code to perform the power on self test (POST). Furthermore, the adaptive device displays a test result via a displayer.

For achieving the objectives above, the present invention provides an adaptive device, which includes a first connector and a second connector respectively capable of connecting with a first read-only memory socket and a second read-only memory socket disposed on a motherboard. Therein, the first read-only memory socket and the second read-only memory socket have different transmission interfaces. If the first connector is used to connect with the first read-only memory socket, the controller performs a first access mode to access the system code from the memory simulator and then passes the system code to the first read-only memory socket via the first connector for the motherboard to execute it. On the other hand, if the second connector is used to connect with the second read-only memory socket, the controller performs a second access mode to access the system code and then passes the system code to the second read-only memory socket via the second connector for the motherboard to execute it. Thus, with the present invention, the present memory simulators can be used with different transmission interfaces to simulate the memory of the motherboard. It is convenient for developers to test system codes.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a conventional memory simulator; and

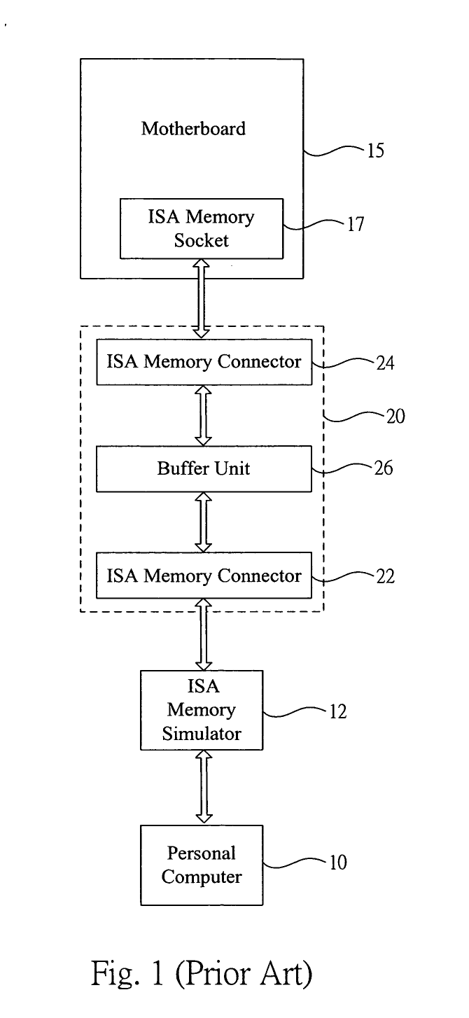

FIG. 2 is a block diagram of a preferred embodiment in accordance with the present invention.

### DETAILED DESCRIPTION OF PREFERRED EMBODIMENTS

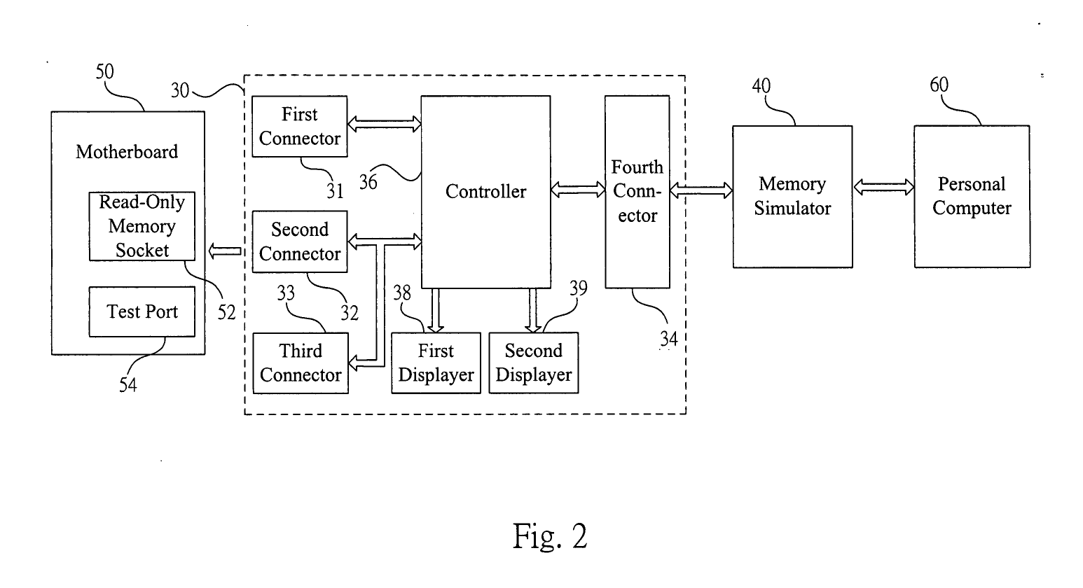

Reference is made to FIG. 2, which is a block diagram of a preferred embodiment in accordance with the present invention. As shown in the figure, the adaptive device 30 of the present invention is used to connect a memory simulator 40 to a motherboard 50. When a device developer uses a PC 60 to transmit a system code, i.e. the BIOS code, to the memory simulator 40 for testing, the motherboard 50 is activated to access the BIOS code temporarily stored in the memory simulator 40 via a read-only memory socket 52 and a test port 54. After the BIOS code is accessed, the motherboard 50 executes the BIOS code. At this moment, depending on the types of the read-only memory socket 52 and the test port 54, the adaptive device 30 uses a suitable mode to access the BIOS code from the memory simulator 40. In the present invention, for conveniently testing the BIOS code, the test port 54 is disposed for the adaptive device 30 to connect the motherboard 50. The test port 54 is a male LPC port in this embodiment.

The adaptive device 30 includes a first connector 31, a second connector 32 a third connector 33 and a fourth connector 34. The first connector 31 is an ISA read-only memory connector, the second connector 32 is a LPC read-only memory connector and the third connector 33 is a LPC female port. If the read-only memory socket 52 of the motherboard 50 is complied with ISA transmission interface standard, the first connector 31 of the adaptive device 30 is used to connect the read-only memory socket 52. If the read-only memory socket 52 of the motherboard 50 is complied with LPC transmission interface standard, the second connector 32 of the adaptive device 30 is used to connect the read-only memory socket 52. The third connector 33 of the adaptive device 30 is used to connect with the test port 54 and the fourth connector 34 of the adaptive device 30 is used to connect with the memory simulator 40. Since all of the present memory simulators use ISA transmission interface to transmit signals, the fourth connector 34 is a connector complied with ISA transmission interface standard.

Depending on the types of the connector connected to the motherboard 50, the controller 36 of the adaptive device 30 uses a suitable access mode to access the BIOS code from the memory simulator 40 and temporarily store it. In case that the first connector 31 is used to connect with the read-only memory socket 52 complied with ISA transmission interface standard, the activated motherboard 50 sends out a control signal via the read-only memory socket 52 for accessing the BIOS code. Then, the control signal is passed to the controller 36 via the first connector 31. Since both of the memory simulator 40 and the read-only memory socket 52 have the parallel-type transmission interface and compatible access clock, the controller 36 uses the first access mode to access the BIOS code. At the first access mode, the controller 36 only temporarily stores the control signal and then passes the control signal to the memory simulator 40 via the fourth connector 34 for accessing the BIOS code. After the control signal is received, the memory simulator 40 passes the BIOS code to the controller 36 via the fourth connector 34. Finally, the controller 36 passes the BIOS code to the read-only memory socket 52 via the first connector 31 for the motherboard 50 to execute it.

In addition, suppose that the second connector 32 is used to connect with the read-only memory socket 52 complied with LPC transmission interface standard. Since the transmission interface of the memory simulator 40 is different to the LPC transmission interface, which is a serial-type transmission interface, the controller 36 uses the second access mode to access the BIOS code. At the second access mode, the controller 36 converts the control signal, which is outputted from the read-only memory socket 52, from the LPC transmission interface standard to the ISA transmission interface standard. In other words, the controller 36 converts the control signal from serial-type format to parallel-type format and coverts the clock from 33 MHz to 8 MHz. In this way, the control signal is transferred to comply with the transmission interface standard of the memory simulator 40. After the control signal is received, the memory simulator 40 passes the BIOS code to the controller 36 via the fourth connector 34. Then, the signals conveying the BIOS code sent from the memory simulator 40 are converted from ISA the transmission interface standard to the LPC transmission interface standard by the controller 36. It means that the controller 36 converts the signals conveying the BIOS code from parallel-type format to serial-type format and coverts the clock from 8 MHz to 33 MHz. In this way, the control signal is transferred to comply with the transmission interface standard of the read-only memory socket 52. Finally, the controller 36 passes the BIOS code to the read-only memory socket 52 via the second connector 32 for the motherboard 50 to execute it.

Likewise, when the third connector 33 is connected to the test port 54, the controller 36 also uses the second access mode to access the BIOS code from the memory simulator 40. It means that the signal outputted from the read-only memory socket 52 is converted from the LPC transmission interface standard to the ISA transmission interface standard by the controller 36 for accessing the BIOS code. Besides, the signals conveying the BIOS code sent from the memory simulator 40 are also converted from the ISA transmission interface standard to the LPC transmission interface standard by the controller 36 to match the transmission interface standard of the test port 54. Then, the controller 36 passes the BIOS code to the r test port 54 via the third connector 33 for the motherboard 50 to execute it. In the present invention, the controller 36 can be an application specific integrated circuit (ASIC) or a complex programmable logic device (CPLD).

Furthermore, in order to make the developer obtain the test result of the BIOS code easily, the adaptive device 30 of the present invention further has a first displayer 38 and a second displayer 39. Both of the first displayer 38 and the second displayer 39 are connected to the controller 36. They can be seven-segment displayers in the present invention. When the motherboard 50 executes the BIOS code and performs the power on self test (POST), the post/debug code generated during the test process is sent to the input/output (I/O) ports 80h and/or 84h. Then, the controller 36 of the present invention intercepts the post/debug code and decodes it and passes the result to the first displayer 38 and the second displayer 39 for the developer's reference. Thereby, the developer can modify the BIOS code without buying or using additional debug or post cards.

Most of the conventional debug cards or the post cards need to be plugged into the motherboard 50 externally for connection. In the present, a high-speed transmission standard, called PCI-Express standard, has been proposed as a transmission interface standard for external connection cards. However, This kind of transmission interface standard defines a signal transmission format that makes the conventional debug cards or the post cards unable to intercept the post/debug code. Therefore, using the present invention to test the BIOS codes can directly obtain the test result and then the developer can modify the BIOS code according to the test result. That is very convenient for the device developer.

Summing up, the adaptive device 30 of the present invention has the connectors 31, 32, 33 with different transmission interface standards to connect with the motherboard 50 via the read-only memory socket 52 and test port 54 disposed on the motherboard 50. Depending on the transmission interface standard that is used, the controller 36 inside the adaptive device 30 uses a suitable access mode to transfer the signals by converting their formats. In this way, the adaptive device 30 can access the BIOS code from the memory simulator 40 for the motherboard 50 to execute it. Thus, the memory simulator 40 is able to be used together with the read-only memory socket 52 or the test port 54 complied with a transmission interface standard different to that of the memory simulator 40 itself. Besides, the adaptive device 30 is capable of intercepting the post/debug code generated by the motherboard 50 that executes the BIOS code to perform the power on self test (POST). After the post/debug code is obtained, the controller 36 decodes the post/debug code and shows the result on the first displayer 38 and the second displayer 39 for developers' reference. That is very convenient to the developers.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. An adaptive device for a memory simulator, used to perform a suitable access mode for a motherboard to access a system code from the memory simulator via a first read-only memory socket or a second read-only memory socket, the adaptive device comprising:
a first connector capable of connecting with the first read-only memory socket;
a second connector capable of connecting with the second read-only memory socket; and
a controller connected with the first connector, the second connector and the memory simulator;
wherein, if the first connector is used to connect with the first read-only memory socket, the controller performs a first access mode to access the system code and then passes the system code to the first read-only memory socket via the first connector for the motherboard to execute it; if the second connector is used to connect with the second read-only memory socket, the controller performs a second access mode to access the system code and then passes the system code to the second read-only memory socket via the second connector for the motherboard to execute it.

2. The adaptive device as claimed in claim 1, wherein the first read-only memory socket is an industry standard architecture (ISA) read-only memory socket, the second read-only memory socket is a low pin count (LPC) read-only memory socket, the first read-only memory socket has a transmission interface that is compatible with the memory simulator; if the first access mode is performed, the controller directly accesses the system code; if the second access mode is performed, the controller converts signal formats of a control signal and signals conveying the system code that are transmitted between the second read-only memory socket and the memory simulator, namely the controller serves as an ISA/LPC transmission interface or a LPC/ISA transmission interface, to access the system code from the memory simulator.

3. The adaptive device as claimed in claim 1, wherein the controller temporarily stores signals transmitted between the first read-only memory socket and the memory simulator or between the second read-only memory socket and the memory simulator.

4. The adaptive device as claimed in claim 1, wherein the motherboard further has a test port, the adaptive device further has a third connector, the third connector is connected with the test port, the controller performs the suitable access mode to access the system code and passes the system code to the test port via the third connector.

5. The adaptive device as claimed in claim 4, wherein the test port is a LPC port, the controller performs the second access mode to convert signal formats of a control signal and signals conveying the system code that are transmitted between the test port and the memory simulator, namely the controller serves as an ISA/LPC transmission interface or a LPC/ISA transmission interface, to access the system code from the memory simulator.

6. The adaptive device as claimed in claim 1, further comprising a fourth connector, which is connected with the memory simulator, the controller accesses the system code from the memory simulator via the fourth connector.

7. The adaptive device as claimed in claim 1, wherein the controller is an application specific integrated circuit.

8. The adaptive device as claimed in claim 1, wherein the controller is a complex programmable login device.

9. The adaptive device as claimed in claim 1, wherein the memory simulator is connected with a computer, which is used to transmit the system code to the memory simulator.

10. An adaptive device for a memory simulator, used to perform a suitable access mode for a motherboard to access a system code from the memory simulator via a first read-only memory socket or a second read-only memory socket, the adaptive device comprising:
a first connector capable of connecting with the first read-only memory socket;
a second connector capable of connecting with the second read-only memory socket;
a controller connected with the first connector, the second connector and the memory simulator; and
a displayer connected with the controller to display a test result that is intercepted by the controller, wherein the test result is generated by the motherboard that executes the system code for testing;
wherein, if the first connector is used to connect with the first read-only memory socket, the controller performs a first access mode to access the system code and then passes the system code to the first read-only memory socket via the first connector for the motherboard to execute it; if the second connector is used to connect with the second read-only memory socket, the controller performs a second access mode to access the system code and then passes the system code to the second read-only memory socket via the second connector for the motherboard to execute it.

11. The adaptive device as claimed in claim 10, wherein the controller intercepts a post/debug code from an input/output (I/O) port 80h of the motherboard, decodes the post/debug code and shows a decoding result on the displayer.

12. The adaptive device as claimed in claim 10, wherein the controller intercepts a post/debug code from an I/O port 84h of the motherboard, decodes the post/debug code and shows a decoding result on the displayer.

13. The adaptive device as claimed in claim 10, wherein the first read-only memory socket is an ISA read-only memory socket, the second read-only memory socket is a LPC read-only memory socket, the first read-only memory socket has a transmission interface that is compatible with the memory simulator; if the first access mode is performed, the controller directly accesses the system code; if the second access mode is performed, the controller converts signal formats of a control signal and signals conveying the system code that are transmitted between the second read-only memory socket and the memory simulator, namely the controller serves as an ISA/LPC transmission interface or a LPC/ISA transmission interface, to access the system code from the memory simulator.

14. The adaptive device as claimed in claim 10, wherein the controller temporarily stores signals transmitted between the first read-only memory socket and the memory simulator or between the second read-only memory socket and the memory simulator.

15. The adaptive device as claimed in claim 10, wherein the motherboard further has a test port, the adaptive device further has a third connector, the third connector is connected with the test port, the controller performs the suitable access mode to access the system code and passes the system code to the test port via the third connector.

16. The adaptive device as claimed in claim 15, wherein the test port is a LPC port, the controller performs the second access mode to convert signal formats of a control signal and signals conveying the system code that are transmitted between the test port and the memory simulator, namely the controller serves as an ISA/LPC transmission interface or a LPC/ISA transmission interface, to access the system code from the memory simulator.

17. The adaptive device as claimed in claim 10, further comprising a fourth connector, which is connected with the memory simulator, the controller accesses the system code from the memory simulator via the fourth connector.

18. The adaptive device as claimed in claim 10, wherein the controller is an application specific integrated circuit.

19. The adaptive device as claimed in claim 10, wherein the controller is a complex programmable login device.

20. The adaptive device as claimed in claim 10, wherein the memory simulator is connected with a computer, which is used to transmit the system code to the memory simulator.
